(19) United States
(12) Patent Application Publication
(10) Pub. No.: US 2024/0430161 A1
(43) Pub. Date: Dec. 26, 2024

(54) METHOD AND APPARATUS FOR REDUCING POWER CONSUMPTION OF COMMUNICATION DEVICE IN SLEEP STATE, AND DEVICE AND MEDIUM

(71) Applicant: HANGZHOU SUPERACME MICROELECTRONICS TECHNOLOGY CO., LTD., Hangzhou (CN)

(72) Inventors: Qinyong Ning, Hangzhou (CN); Guo Ai, Hangzhou (CN); Zuoxing Yang, Hangzhou (CN); Ruming Fang, Hangzhou (CN); Zhihong Xiang, Hangzhou (CN)

(21) Appl. No.: 18/700,555

(22) PCT Filed: Oct. 13, 2022
(86) PCT No.: PCT/CN2022/125087

§ 371 Date: Apr. 11, 2024

(30) Foreign Application Priority Data
Oct. 22, 2021 (CN) 202111231502.1

(51) Int. Cl. H04L 41/0833; H04L 67/145

(52) U.S. Cl. CPC H04L 41/0833; H04L 67/145

(57) ABSTRACT

The present application discloses a method for reducing power consumption of a communication device in a sleep state. The method includes: when the communication device is in the sleep state, detecting an running state of a current network, and setting a next keep-alive probing period of a persistent connection according to the running state of the current network such that the next keep-alive probing period of the persistent connection is at least extended on the basis of a current keep-alive probing period when the running state of the current network is an idle state.

### CROSS-REFERENCE TO RELATED APPLICATIONS

This application is a national stage application of International Patent Application No. PCT/CN2022/125087, filed Oct. 13, 2022, entitled “Method and Apparatus for Reducing Power Consumption of Communication Device in Sleep State, and Device and Medium,” which claims priority from Chinese Patent Application No. 202111231502.1 entitled “Method and Apparatus for Reducing Power Consumption of Communication Device in Sleep State”, filed to China National Intellectual Property Administration on Oct. 22, 2021, the entire contents of which are incorporated herein by reference.

### TECHNICAL FIELD

The present application relates to the field of communications, and more particularly relates to a method and apparatus for reducing power consumption of a communication device in a sleep state, a communication device and a storage medium.

### BACKGROUND ART

When two processes communicate, a connection needs to be established therebetween to transmit data to each other. When different processes are deployed on different servers, or different terminals, or when one process is deployed on a server and another process is deployed on a terminal, TCP/IP based communication is usually required, whether it is a remote procedure call (RPC) between application programs or a call between an application program and a database (DAL, Database Access Layer).

During TCP/IP connection establishment, a connection can be established between both communicating parties after they go through a three-way handshake, and after data transmission ends, the established connection can be closed after both communicating parties go through a four-way handshake. In order to eliminate the overhead of establishing and closing a connection in multiple communications, and overall, to make the total time spent of performing multiple data transmissions less, a persistent connection is often employed. The persistent connection means that after one data transmission is performed, the connection is not closed, and a connected state is maintained for a long time. If there is new data to be transmitted between two application programs, this connection is directly reused, and there is no need to establish a new connection. However, additional effort is required to keep the persistent connection available all the time, as network jitter, server failures, and even firewall issues will make the connection unavailable. Therefore, both communicating parties have introduced a keep-alive probing mechanism that periodically sends a probing heartbeat packet, that is, a probing packet is sent periodically to identify whether the other party is reachable to ensure that the connection is available when used.

### SUMMARY

An embodiment of the present application provides a method and apparatus for reducing power consumption of a communication device in a sleep state, an electronic device and a storage medium, which not only guarantee that a persistent connection is available but also reduce power consumption.

An embodiment of the present application provides a method for reducing power consumption of a communication device in a sleep state, carried out by the communication device, wherein a persistent connection used for transmitting data is established between the communication device and a counter-party communication device, and the method includes:

detecting a running state of a current network when the communication device is in the sleep state; and
setting a next keep-alive probing period of the persistent connection according to the running state of the current network such that the next keep-alive probing period of the persistent connection is at least extended on the basis of a current keep-alive probing period when the running state of the current network is an idle state.

An embodiment of the present application also provides an apparatus for reducing power consumption of a communication device in a sleep state, where the apparatus is provided in the communication device, a persistent connection configured for transmitting data is established between the communication device and a counter-party communication device, and the apparatus includes:

a first detection module, configured to detect a running state of a current network when the communication device is in the sleep state; and
a first setting module, configured to set a next keep-alive probing period of the persistent connection according to the running state of the current network detected by the first detection module such that the next keep-alive probing period of the persistent connection is at least extended on the basis of a current keep-alive probing period when the running state of the current network is an idle state.

An embodiment of the present application further provides a communication device, including: a processor; and a memory connected to the processor; machine-readable instructions are stored in the memory; the machine-readable instructions, when executed by the processor, implement the method for reducing power consumption of the communication device in the sleep state as described.

An embodiment of the present application also provides a computer-readable storage medium having stored therein a computer program that, when executed by a processor, implements the steps of the method for reducing power consumption of the communication device in the sleep state as described.

An embodiment of the present application also provides a computer program product, including a computer instruction stored in a computer-readable storage medium that, when executed, implements the above-mentioned method for reducing power consumption of the communication device in the sleep state.

According to the method for reducing power consumption of a communication device in a sleep state provided by the embodiment of the present application, the next keep-alive probing period of the persistent connection is set according to the running state of the current network, and thus, the set keep-alive probing periods may vary depending on busy and idle states of a network during operation, so that the keep-alive probing periods can be adjusted adaptively according to running states of the network, which not only can guarantee normal operation of a keep-alive probing mechanism of the persistent connection, helps to keep the persistent connection in an available state in real time, but also can help to reduce the frequency of sending a probing heartbeat packet when the keep-alive probing mechanism operates, thereby helping to reduce the power consumption.

### BRIEF DESCRIPTION OF THE DRAWINGS

FIGS. 1A and 1B are flow charts of a method for reducing power consumption of a communication device in a sleep state in an embodiment of the present application.

FIG. 2 is another flow chart of a method for reducing power consumption of a terminal device in a sleep state in an embodiment of the present application.

FIG. 3 is a schematic diagram of changes of keep-alive probing periods in a sleep state in an embodiment of the present application.

FIG. 4 is a schematic structural diagram of an apparatus for reducing power consumption of a communication device in a sleep state in an embodiment of the present application.

FIG. 5 is a schematic structural diagram of a communication device in an embodiment of the present application.

### DETAILED DESCRIPTION OF THE INVENTION

In order to make the objects, technical means and advantages of the present application more clearly understood, the present application is further described in detail below in conjunction with the accompanying drawings.

In order to guarantee that a persistent connection is available, a keep-alive probing period is usually set to be a fixed and relatively short time length. For example, a probing heartbeat packet is sent with a keep-alive probing period of 3 or 5 min, which will result in relatively high power consumption in a case that the frequency of sending the probing heartbeat packet is relatively high in the sleep state. In view of this, an embodiment of the present application provides a method for reducing power consumption of a communication device in a sleep state, which implements intelligent setting of a keep-alive probing period through an adaptive adjustment of the keep-alive probing period, thereby both guaranteeing that a persistent connection is available and helping to reduce the power consumption.

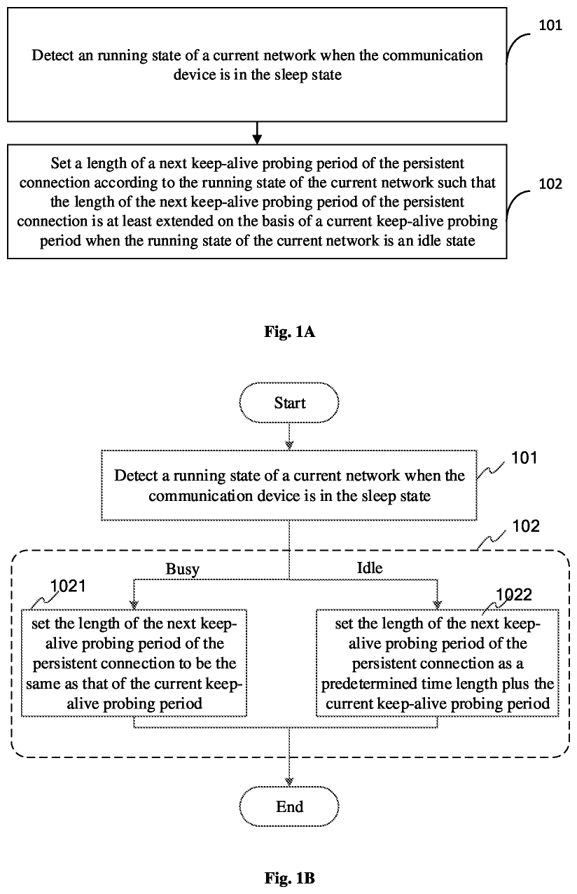

With reference to FIG. 1A, FIG. 1A is a flow chart of a method for reducing power consumption of a communication device in a sleep state in an embodiment of the present application. The method can be executed by a communication device such as a terminal device, a server or the like. A persistent connection used for transmitting data is established between the communication device and a counter-party communication device. The method includes:

step 101: Detect a running state of a current network when the communication device is in the sleep state; and
step 102: Set a length of a next keep-alive probing period of the persistent connection according to the running state of the current network such that the length of the next keep-alive probing period of the persistent connection is at least extended on the basis of a current keep-alive probing period when the running state of the current network is an idle state.

In some embodiments, with reference to FIG. 1B, the set a length of a next keep-alive probing period of the persistent connection according to the running state of the current network in step 102 may include:

1021: If the running state of the current network indicates that the network is busy, set the length of the next keep-alive probing period of the persistent connection to be the same as that of the current keep-alive probing period. For example, if the length of the current keep-alive probing period is a first time length, keep the length of the next keep-alive probing period the same as the first time length.
1022: if the running state of the current network indicates that the network is idle, set the length of the next keep-alive probing period of the persistent connection as a predetermined time length plus the current keep-alive probing period. For example, if the length of the current keep-alive probing period is the first time length, set the next keep-alive probing period to be a second time length, where the second time length is greater than the first time length.

For the convenience of understanding of the present application, it will be illustrated below with taking a persistent connection between a terminal device and a server as an example. It should be understood that it is not limited thereto, and any persistent connection between two communicating parties may be applicable.

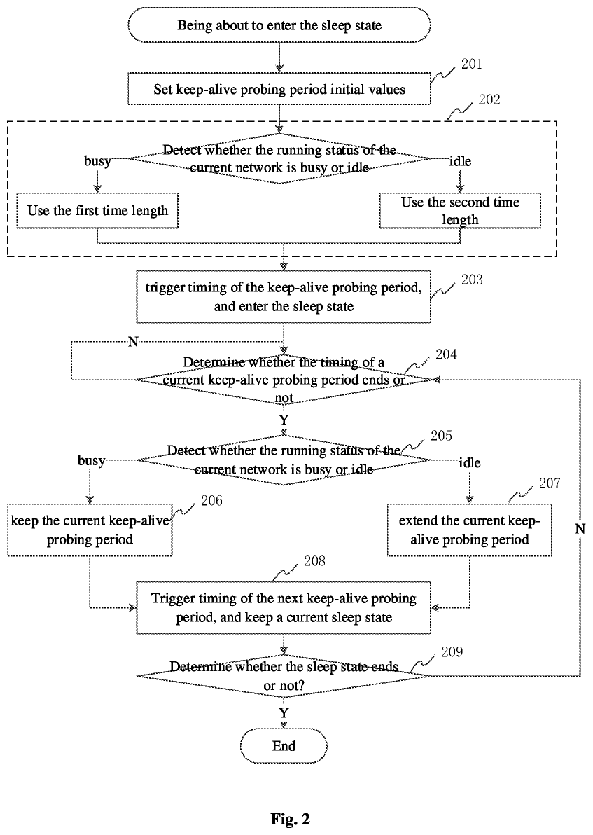

With reference to FIG. 2, FIG. 2 is a flow chart of a method for reducing power consumption of a terminal device in a sleep state in an embodiment of the present application. For any communication device of both communication parties, when the communication device is about to enter the sleep state, for example, when the terminal device detects that a trigger condition for the communication device to enter the sleep state is currently met, the following steps are executed:

Step 201: Set keep-alive probing period initial values, including a keep-alive probing period initial value in a network busy state and a keep-alive probing period initial value in a network idle state, where the keep-alive probing period initial value in the network busy state is a first time length, and the keep-alive probing period initial value in the network idle state is a second time length, where the second time length is greater than the first time length.
Step 202: Detect a running state of a current network, and if the current network is in the busy state, use the first time length, e.g., 5 min, such that a persistent connection is kept from being disconnected, and closing of the persistent connection due to a busy network is avoided; and if the current network is in the idle state, use the second time length, e.g., 15 min.

In some embodiments, a probing packet includes: at least one of a ping data packet or a probing heartbeat packet, a way to detect the running state of the current network may include at least one of:

sending, by the communication device, a probing packet such as a ping data packet, to a counter-party device in a persistent connection thereto; receiving a probing response packet from the counter-party device, determining the running state of the current network according to a time interval between the sent probing data packet and the received probing response packet, and if the time interval is greater than a set time threshold value, determining the running state of the current network as that the network is busy, and otherwise, determining the running state of the current network as that the network is idle;
or
sending, by the communication device, a probing packet such as a probing heartbeat packet to a counter-party device in a persistent connection thereto; receiving a reply probing heartbeat packet from the counter-party device, determining the running state of the current network according to a time interval between the sent probing heartbeat packet and the received probing heartbeat packet, and if the time interval is greater than a set time threshold value, determining the running state of the current network as that the network is busy, and otherwise, determining the running state of the current network as that the network is idle. The running state of the current network is detected by using the heartbeat packet, and the detection of the running state of the network and keep-alive detection can be integrated into one instruction, and thus, both keep-alive detection and the detection of the running state of the current network are performed, which reduces instruction processing in a sleep state, thereby helping to reduce power consumption;
or
sending, by the communication device, a paging message to a base station to which the communication device accesses, receiving a paging response message from the base station, determining the running state of the current network according to a time interval between the sent paging message and the received paging response message, and if the time interval is greater than a set time threshold value, determining the running state of the current network as that the network is busy, and otherwise, determining the running state of the current network as that the network is idle.

Step 203: After setting a keep-alive probing period, trigger timing of the keep-alive probing period, and enter the sleep state.

Step 204: Determine whether the timing of a current keep-alive probing period ends or not, if it ends, step 205 is performed, and if not, return to step 204.

Step 205: Detect the running state of the current network, and if the current network is in the busy state, step 206 is performed: keep the current keep-alive probing period, i.e., keep a length of a next keep-alive probing period the same as that of the current keep-alive probing period. If the network is in the idle state, step 207 is performed: extend the current keep-alive probing period, for example, add a third time length to the current keep-alive probing period, which serves as the next keep-alive probing period.

Step 208: Trigger timing of the next keep-alive probing period, and keep a current sleep state.

Step 209: Determine whether the sleep state ends or not, and if it ends, this flow is ended, and the sleep state of the communication device is ended, and a normal running state is entered, and otherwise, return to step 204: determine whether the timing of a current keep-alive probing period ends or not.

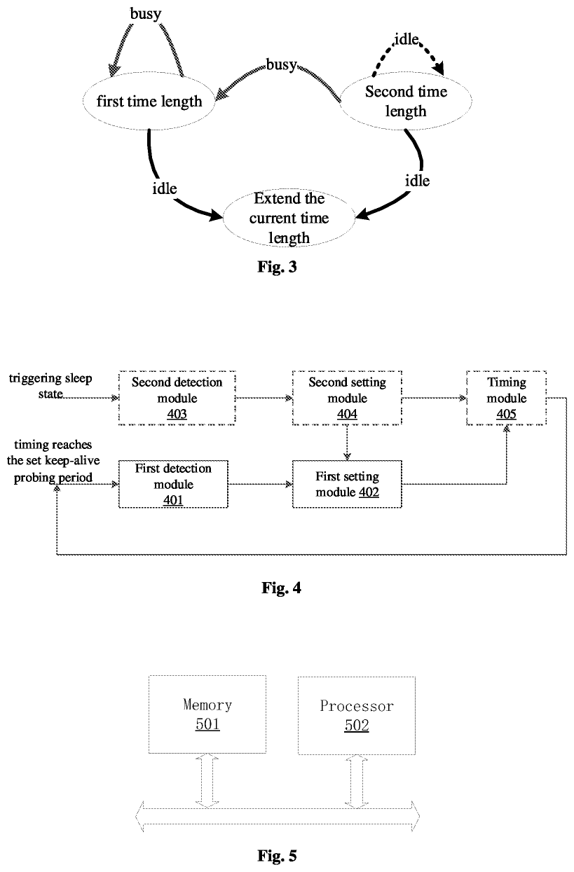

With reference to FIG. 3, FIG. 3 is a schematic diagram of changes of keep-alive probing periods in a sleep state in an embodiment of the present application.

When the current keep-alive probing period is a first time length t1, if the current network is in the busy state, the next keep-alive probing period can be kept unchanged, which is the first time length t1, and if the current network is in the idle state, the next keep-alive probing period can be extended on the basis of the current keep-alive probing period. For example, a third time length t3 is added to the current keep-alive probing period, i.e., t1+t3. After n keep-alive probing periods, if the network remains in the idle state all the time, a length of the keep-alive probing period after n extensions may be t1+n*t3.

When the current keep-alive probing period is a second time length t2, if the current network is in the busy state, the current keep-alive probing period can be shortened, to serve as the next keep-alive probing period, for example, the next keep-alive probing period may be the first time length t1; if the current network is in the idle state, the current keep-alive probing period can be kept, or the current keep-alive probing period can be extended according to a time interval between a sent probing heartbeat packet and a received probing heartbeat packet, wherein an extended current keep-alive probing period serves as the next keep-alive probing period, for example, a third time length t3 is added to the current keep-alive probing period, i.e., t2+t3. A length of the keep-alive probing period after n extensions may be t2+n*t3, where n is the number of extensions, and t3 is the third time length.

From this, it can be seen that the keep-alive probing period has various numerical values with different running states and continuous running states of the network, thereby implementing intelligent setting of the keep-alive probing period.

Considering that the time interval between the sent probing packet and the received probing response packet, the time interval between the sent probing heartbeat packet and the received probing heartbeat packet, and the time interval between the sent paging message and the received paging response message can reflect busy and idle degrees of the current network to a certain extent, the larger the current time interval is, the busier the current network is, and the smaller the current time interval is, the idler the current network is. Therefore, the first time length, the second time length and the third time length can be determined respectively according to a corresponding current time interval. In this step, considering detecting the running state of the current network is performed after the end of the timing of the current keep-alive probing period, and a probing heartbeat packet usually needs to be sent at the end of the timing of the keep-alive probing period, in some embodiments, the running state of the current network is detected using the probing heartbeat packet. After the next keep-alive probing period is set, the sleep state is kept, and the timing of the next keep-alive probing period is triggered.

In this embodiment, the keep-alive probing period is set according to the running state of the network in the sleep state, such that the keep-alive probing period is intelligently set. Moreover, as the network idle state continues, the time length of the keep-alive probing period can be cumulatively increased until a set maximum time length is reached, e.g., a time length specified by a protocol standard. Thus, both the persistent connection can be kept available and the number of the sent probing heartbeat packets is reduced, thereby helping to reduce the power consumption.

With reference to FIG. 4, FIG. 4 is a schematic diagram of an apparatus for reducing power consumption of a communication device in a sleep state in an embodiment of the present application. In some embodiments, the apparatus can be provided in the communication device, a persistent connection configured for transmitting data is established between the communication device and a counter-party communication device, and the apparatus includes:

a first detection module 401, configured to detect a running state of a current network when the communication device is in the sleep state; and
a first setting module 402, configured to set a next keep-alive probing period of the persistent connection according to the running state of the current network detected by the first detection module 401 such that the next keep-alive probing period of the persistent connection is at least extended on the basis of a current keep-alive probing period when the running state of the current network is an idle state.

In some embodiments, the apparatus further includes:

a timing module 405, configured to perform timing according to a set keep-alive probing period, and when the timing reaches the set keep-alive probing period, trigger the first detection module 401 to detect the running state of the network.

The first detection module 401 is further configured to: detect the running state of the current network in response to the timing of the current keep-alive probing period of the timing module 405 ends.

In some embodiments, the first setting module 402 is further configured to:

if the running state of the current network indicates that the network is busy, set a length of the next keep-alive probing period of the persistent connection to be the same as that of the current keep-alive probing period, i.e., keep the current keep-alive probing period; and
if the running state of the current network indicates that the network is idle, set the length of the next keep-alive probing period of the persistent connection as a predetermined time length plus the current keep-alive probing period, where the predetermined time length may be, for example, a third time length.

In some embodiments, the apparatus further includes:

a second detection module 403, configured to detect the running state of the current network in response to a trigger signal that the communication device meets the condition for entering the sleep state;
a second setting module 404, configured to set a keep-alive probing period initial value of the persistent connection according to the running state of the current network detected by the second detection module 403; if the running state of the current network indicates that the network is busy, set the keep-alive probing period initial value of the persistent connection as a first time length; if the running state of the current network indicates that the network is idle, set the keep-alive probing period initial value of the persistent connection as a second time length, where the second time length is greater than the first time length; and after setting the current keep-alive probing period initial value, control the communication device to enter the sleep state, and trigger timing of a keep-alive probing period.

In some embodiments, the first detection module 401 and the second detection module 403 are further configured to:

send at least one of a probing packet or a paging message to the counter-party communication device;
receive at least one of a probing response packet or a paging response message from the counter-party communication device; and
if at least one of a time interval between sending time and receiving time of the probing response packet or paging response message is greater than a set time threshold value, determine the running state of the current network as that the network is busy; and otherwise, determine the running state of the current network as that the network is idle.

In some embodiments, the probing packet includes: at least one of a ping data packet or a probing heartbeat packet.

In some embodiments, the first time length, the second time length and the third time length are determined according to a transmission delay between the communication device and the counter-party communication device. In some embodiments, the transmission delay is a time interval between sending time and receiving time of the at least one of the probing response packet or paging response message.

With reference to FIG. 5, FIG. 5 is a schematic diagram of a communication device of the present application. The communication device includes a memory 501 and a processor 502, where the memory 501 stores a computer program, and the processor 502 is configured to execute the computer program to implement the steps of method of reducing power consumption of the communication device in a sleep state of the present application. The memory 501 may include a random access memory (RAM) or a non-volatile memory (NVM), e.g., at least one disk memory. Optionally, the memory 510 may also be at least one storage apparatus located remotely from the aforementioned processor 502.

The above-mentioned processor 502 may be a general-purpose processor, including a central processing unit (CPU), a network processor (NP) and the like. It may also be a digital signal processor (DSP), an application specific integrated circuit (ASIC), a field-programmable gate array (FPGA) or other programmable logic devices, a discrete gate or a transistor logic device, a discrete hardware component.

The communication device may also include an apparatus for reducing power consumption of a communication device in a sleep state as shown in FIG. 4.

An embodiment of the present application also provides a computer-readable storage medium having stored therein a computer program that, when executed by a processor, implements the method for reducing power consumption of a communication device in a sleep state.

An embodiment of the present application also provides a computer program product, including a computer instruction stored in a computer-readable storage medium that, when executed, implements the above-mentioned method for reducing power consumption of a communication device in a sleep state.

For apparatus/network side device/storage medium embodiments, since they are basically similar to method embodiments, the description is relatively simple. For related parts, refer to the partial description of the method embodiments.

Herein, relational terms such as first and second are only used to distinguish one entity or operation from another entity or operation, without necessarily requiring or implying any such actual relationship or order between these entities or operations. Moreover, the terms “include”, “comprise”, or any other variation thereof are intended to encompass non-exclusive inclusion, such that a process, a method, an article, or a device including a series of elements includes not only those elements, but also includes other elements that are not expressly listed, or further includes elements inherent to such process, method, article or device. Without further restrictions, the element defined by the statement “including a . . . ” does not exclude the existence of another identical element in the process, method, article or apparatus including the elements.

The foregoing is only a better embodiment of the present application and is not used to limit the present application, and any modifications, equivalent replacements, improvements and the like made within the principles of the present application shall be included in the scope of protection of the present application.

1. A method for reducing power consumption of a communication device in a sleep state, carried out by the communication device, wherein a persistent connection used for transmitting data is established between the communication device and a counter-party communication device, and the method comprises:
detecting a running state of a current network when the communication device is in the sleep state; and
setting a next keep-alive probing period of the persistent connection according to the running state of the current network such that the next keep-alive probing period of the persistent connection is at least extended on the basis of a current keep-alive probing period when the running state of the current network is an idle state.

2. The method of claim 1, wherein the detecting the running state of a current network comprises:
detecting the running state of the current network in response to the timing of the current keep-alive probing period of the persistent connection ends.

3. The method of claim 1, further comprising:
detecting the running state of the current network in response to a trigger signal that the communication device meets the condition for entering the sleep state;
setting a keep-alive probing period initial value of the persistent connection according to the running state of the current network; if the running state of the current network indicates that the network is busy, setting the keep-alive probing period initial value of the persistent connection as a first time length; if the running state of the current network indicates that the network is idle, setting the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, controlling the communication device to enter the sleep state, and triggering timing of a keep-alive probing period.

4. The method of claim 3, wherein the setting the next keep-alive probing period of the persistent connection according to the running state of the current network such that the next keep-alive probing period of the persistent connection is at least extended on the basis of a current keep-alive probing period when the running state of the current network is an idle state comprises:
when the current keep-alive probing period is the first time length:
if the running state of the current network indicates that the network is busy, setting a length of the next keep-alive probing period of the persistent connection to be the same as that of the current keep-alive probing period;
if the running state of the current network indicates that the network is idle, setting the next keep-alive probing period of the persistent connection as an extension of a third time length on the basis of the current keep-alive probing period; wherein the third time length is determined according to the transmission delay between the communication device and the counter-party communication device.

5. The method of claim 4, wherein the setting the next keep-alive probing period of the persistent connection according to the operating state of the current network such that the next keep-alive probing period of the persistent connection is at least extended on the basis of a current keep-alive probing period when the operating state of the current network is an idle state further comprises:
when the current keep-alive probing period is the second time length:
if the running state of the current network indicates that the network is busy, shortening the current keep-alive probing period to serve as the next keep-alive probing period;
if the running state of the current network indicates that the network is idle, setting the length of the next keep-alive probing period to be the same as that of the current keep-alive probing period.

6. The method of claim 1, wherein the detecting the running state of a current network comprises:
sending at least one of a probing packet or a paging message to the counter-party communication device;
receiving at least one of a probing response packet or a paging response message from the counter-party communication device; and
if at least one of a time interval between sending time of the probing packet and receiving time of the probing response packet, or a time interval between sending time of the paging message and receiving time of the paging response message are/is greater than a set time threshold value, determining that the current network is busy,
otherwise, determining that the current network is idle.

7. The method of claim 6, wherein the probing packet is at least one of a ping data packet or a probing heartbeat packet.

8-14. (canceled)

15. A communication device, comprising: a processor; a memory connected to the processor, wherein machine-readable instructions are stored in the memory; the processor when executing the machine-readable instructions, is configured to:
detect a running state of a current network when the communication device is in the sleep state; and
set a next keep-alive probing period of the persistent connection according to the running state of the current network such that the next keep-alive probing period of the persistent connection is at least extended on the basis of a current keep-alive probing period when the running state of the current network is an idle state.

16. A non-transitory computer-readable storage medium having stored therein a computer program that, when executed by a processor, implements the method for reducing power consumption of a communication device in a sleep state, the method comprising:
detecting a running state of a current network when the communication device is in the sleep state; and
setting a next keep-alive probing period of the persistent connection according to the running state of the current network such that the next keep-alive probing period of the persistent connection is at least extended on the basis of a current keep-alive probing period when the running state of the current network is an idle state.

17. (canceled)

18. The method of claim 2, further comprising:
detecting the running state of the current network in response to a trigger signal that the communication device meets the condition for entering the sleep state;
setting a keep-alive probing period initial value of the persistent connection according to the running state of the current network; if the running state of the current network indicates that the network is busy, setting the keep-alive probing period initial value of the persistent connection as a first time length; if the running state of the current network indicates that the network is idle, setting the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, controlling the communication device to enter the sleep state, and triggering timing of a keep-alive probing period.

19. The communication device according to claim 15, wherein the processor is configured to:
detect the running state of the current network in response to the timing of the current keep-alive probing period of the persistent connection ends.

20. The communication device according to claim 15, wherein the processor is configured to:
detect the running state of the current network in response to a trigger signal that the communication device meets the condition for entering the sleep state;
set a keep-alive probing period initial value of the persistent connection according to the running state of the current network; if the running state of the current network indicates that the network is busy, set the keep-alive probing period initial value of the persistent connection as a first time length; if the running state of the current network indicates that the network is idle, set the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, control the communication device to enter the sleep state, and trigger timing of a keep-alive probing period.

21. The communication device according to claim 19, wherein the processor is configured to:
detect the running state of the current network in response to a trigger signal that the communication device meets the condition for entering the sleep state;
set a keep-alive probing period initial value of the persistent connection according to the running state of the current network; if the running state of the current network indicates that the network is busy, set the keep-alive probing period initial value of the persistent connection as a first time length; if the running state of the current network indicates that the network is idle, set the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, control the communication device to enter the sleep state, and trigger timing of a keep-alive probing period.

22. The communication device according to claim 21, wherein the processor is configured to:
when the current keep-alive probing period is the first time length:
if the running state of the current network indicates that the network is busy, set a length of the next keep-alive probing period of the persistent connection to be the same as that of the current keep-alive probing period; and
if the running state of the current network indicates that the network is idle, set the next keep-alive probing period of the persistent connection as an extension of a third time length on the basis of the current keep-alive probing period; wherein the third time length is determined according to the transmission delay between the communication device and the counter-party communication device.

23. The communication device according to claim 22, wherein the processor is configured to:
when the current keep-alive probing period is the second time length:
if the running state of the current network indicates that the network is busy, shorten the current keep-alive probing period to serve as the next keep-alive probing period; and
if the running state of the current network indicates that the network is idle, set the length of the next keep-alive probing period to be the same as that of the current keep-alive probing period.

24. The communication device according to claim 15, wherein the processor is configured to:
send at least one of a probing packet or a paging message to the counter-party communication device;
receive at least one of a probing response packet or a paging response message from the counter-party communication device; and
if at least one of a time interval between sending time of the probing packet and receiving time of the probing response packet, or a time interval between sending time of the paging message and receiving time of the paging response message are/is greater than a set time threshold value, determine that the current network is busy,
otherwise, determine that the current network is idle.

25. The non-transitory computer-readable storage medium according to claim 16, wherein the method comprises:
detecting the running state of the current network in response to the timing of the current keep-alive probing period of the persistent connection ends.

26. The non-transitory computer-readable storage medium according to claim 16, wherein the method further comprises:
detecting the running state of the current network in response to a trigger signal that the communication device meets the condition for entering the sleep state;
setting a keep-alive probing period initial value of the persistent connection according to the running state of the current network; if the running state of the current network indicates that the network is busy, setting the keep-alive probing period initial value of the persistent connection as a first time length; if the running state of the current network indicates that the network is idle, setting the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, controlling the communication device to enter the sleep state, and triggering timing of a keep-alive probing period.

27. The non-transitory computer-readable storage medium according to claim 25, wherein the method further comprises:
detecting the running state of the current network in response to a trigger signal that the communication device meets the condition for entering the sleep state;
setting a keep-alive probing period initial value of the persistent connection according to the running state of the current network; if the running state of the current network indicates that the network is busy, setting the keep-alive probing period initial value of the persistent connection as a first time length; if the running state of the current network indicates that the network is idle, setting the keep-alive probing period initial value of the persistent connection as a second time length, wherein the second time length is greater than the first time length; and the first time length and the second time length are determined according to a transmission delay between the communication device and the counter-party communication device; and
after setting the current keep-alive probing period initial value, controlling the communication device to enter the sleep state, and triggering timing of a keep-alive probing period.

28. The non-transitory computer-readable storage medium according to claim 27, wherein the method further comprises:
when the current keep-alive probing period is the first time length:
if the running state of the current network indicates that the network is busy, setting a length of the next keep-alive probing period of the persistent connection to be the same as that of the current keep-alive probing period; and
if the running state of the current network indicates that the network is idle, setting the next keep-alive probing period of the persistent connection as an extension of a third time length on the basis of the current keep-alive probing period; wherein the third time length is determined according to the transmission delay between the communication device and the counter-party communication device.
